(19) United States
(12) Patent Application Publication
(10) Pub. No.: US 2013/0126385 A1
(43) Pub. Date: May 23, 2013

(54) PACKAGE AND KITCHEN CLEANING COMPOSITION

(71) Applicant: Lynda Weaver, Bouse, AZ (US)

(72) Inventor: Lynda Weaver, Bouse, AZ (US)

(21) Appl. No.: 13/300,612

(22) Filed: Nov. 20, 2011

(51) Int. Cl. B65D 85/00; C11D 17/00; C11D 7/60

(52) U.S. Cl. 206/524.1; 510/194

(57) ABSTRACT

The present invention is a package of a kitchen cleaning composition that includes a base package with a front portion, a top edge and a bottom edge, where the top edge can be torn or ripped by hand to open the base package providing access to the kitchen cleaning composition and the bottom edge is sealed but is tearable to open the base package and the kitchen cleaning composition that is utilized to clean and sanitize a garbage disposal that consists of dried grapefruit peel and a plurality of fragrances that include lemon, lime, orange, grape, strawberry, coconut, watermelon, cantaloupe, peach, peppermint, cinnamon, pine, citrus, lilac, vanilla, flowers, licorice or cherry natural or artificial fragrance.

### TECHNICAL FIELD & BACKGROUND

Traditionally, after long periods of use, waste builds-up inside a kitchen appliance causing the appliance and the surrounding air to become very dirty and soiled. Currently there are limited alternatives to fresheners and cleaning compositions that have the capability of sanitizing and cleaning kitchen appliances in an organic and chemical-free fashion.

The present invention generally relates to a package and cleaning composition. More specifically, the invention is a package and kitchen cleaning composition.

It is an object of the invention to provide a package and kitchen cleaning composition that includes dried grapefruit peel and fragrance or liquefied fragranced grapefruit peel.

It is an object of the invention to provide a package and kitchen cleaning composition that includes dried grapefruit peel and fragrance that is available in a convenient package.

It is an object of the invention to provide a package and kitchen cleaning composition that is utilized to clean and sanitize a garbage disposal or other kitchen appliance.

What is really needed is a package and kitchen cleaning composition that includes dried grapefruit peel and fragrance or liquefied fragranced grapefruit peel that is available in a convenient package that is utilized to clean and sanitize a garbage disposal or other kitchen appliance.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front side perspective view of a package of kitchen cleaning composition, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

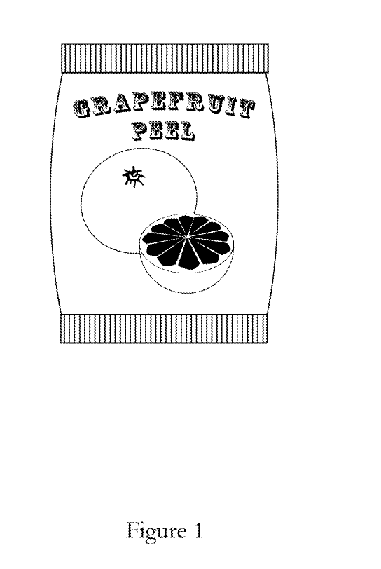

FIG. 1 illustrates a front side perspective view of a package 100 of kitchen cleaning composition, in accordance with one embodiment of the present invention.

The package 100 includes a base package 110 and a kitchen cleaning composition 120. The base package 110 can be made of paper, plastic, aluminum foil or other suitable material. The base package 110 has a top edge 112 that can be typically torn or ripped by hand that opens the base package 110 that provides access to kitchen cleaning composition 120. The top edge 112 can also be resealable or any other suitable top edge. The base package 110 also has a sealed bottom edge 114 that may also be tearable as well to open the base package 110. The base package 110 also includes a grapefruit-related indicia 116 such as a picture of a grapefruit that is disposed on a front portion 118 of the base package 110. The base package 110 can also be a half gallon container that is similar to a milk carton of kitchen cleaning composition 120 or any other suitable container.

The kitchen cleaning composition 120 consists of dried grapefruit peel 122 and a fragrance 124, although fresh grapefruit peel can also be incorporated into the composition in place of dried grapefruit peel 122 as well. The kitchen cleaning composition 120 is typically utilized to clean and sanitize a garbage disposal. The dried grapefruit peel 122 can be in a chip form 126 that is an approximate greater or less than 1 inch square pieces where these dimensions are suitable for producing an aroma when crushed by a garbage disposal. The dried grapefruit peel 122 can also be liquefied to a relatively thin liquid composition or a relatively thick liquid composition and then dried to form a solid form and be suitably shaped and configured as desired. The fragrance 124 can include lemon, lime, orange, grape, strawberry, coconut, watermelon, cantaloupe, peach, peppermint, cinnamon, pine, citrus, lilac, vanilla, flowers, licorice or cherry fragrance. The fragrance 124 can be natural or artificial.

Comprised of dried grapefruit peels, the kitchen cleaning composition is introduced to the garbage disposal through the sink's drain where the garbage disposal is located. The kitchen cleaning composition is designed to break down inside the garbage disposal, grinding the peel into tiny pieces which sweep against the walls of the garbage disposal releasing a light aroma that purifies the air. Easy to use, this fragrant fruit sanitizes the drainage area with its natural exfoliates and citric acids afforded to grapefruits. The kitchen cleaning composition may be readily available at retail household stores in various sizes and quantities. The kitchen cleaning composition can be used in both its natural state or dried, producing the same pleasurable scent. The kitchen cleaning composition features a refreshing fruity aroma that fills the air with natural fragrance, free of artificial materials.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A package of a kitchen cleaning composition, comprising:
a base package with a front portion, a top edge and a bottom edge, where said top edge is torn or ripped by hand to open said base package providing access to said kitchen cleaning composition and said bottom edge is sealed but is tearable to open said base package; and
said kitchen cleaning composition that is utilized to clean and sanitize a garbage disposal that consists of dried grapefruit peel and a fragrance that is selected from the group consisting of lemon, lime, orange, grape, strawberry, coconut, watermelon, cantaloupe, peach, peppermint, cinnamon, pine, citrus, lilac, vanilla, flowers, licorice or cherry natural or artificial fragrance.

2. The package according to claim 1, wherein said top edge is resealable.

3. The package according to claim 1, wherein said base package includes a grapefruit-related indicia disposed on said front portion of said base package.

4. The package according to claim 1, wherein said base package is made of material selected from the group consisting of paper, plastic or aluminum foil.

5. The package according to claim 1, wherein said dried grapefruit peel is substituted with fresh grapefruit peel.

6. The package according to claim 1, wherein said dried grapefruit peel is in a chip form.

7. The package according to claim 6, wherein said chip form is approximately greater or less than a plurality of 1 inch square pieces.

8. The package according to claim 1, wherein said dried grapefruit peel is liquefied to a relatively thin liquid composition or a relatively thick liquid composition and then dried to form a solid and be shaped and configured as desired.

9. A kitchen cleaning composition that is utilized to clean and sanitize a garbage disposal, consisting of:
dried grapefruit peel; and
a fragrance.

10. The package according to claim 9, wherein said fragrance is natural or artificial.

11. The package according to claim 9, wherein said dried grapefruit peel is replaced with fresh grapefruit peel.

12. The package according to claim 9, wherein said dried grapefruit peel is in a chip form.

13. The package according to claim 9, wherein said chip form is approximately greater or less than a plurality of 1 inch square pieces.

14. The package according to claim 9, wherein said dried grapefruit peel is liquefied to a relatively thin liquid composition or a relatively thick liquid composition and then dried to form a solid and be shaped and configured as desired.

15. The package according to claim 9, wherein said fragrance is selected from the group consisting of lemon, lime or orange natural or artificial fragrance.

16. The package according to claim 9, wherein said fragrance is selected from the group consisting of grape, strawberry or coconut natural or artificial fragrance.

17. The package according to claim 9, wherein said fragrance is selected from the group consisting of watermelon, cantaloupe or peach natural or artificial fragrance.

18. The package according to claim 9, wherein said fragrance is selected from the group consisting of peppermint, cinnamon or pine natural or artificial fragrance.

19. The package according to claim 9, wherein said fragrance is selected from the group consisting of citrus, lilac or vanilla natural or artificial fragrance.

20. The package according to claim 9, wherein said fragrance is selected from the group consisting of flowers, licorice or cherry natural or artificial fragrance.
